(19) United States
(12) Patent Application Publication
(10) Pub. No.: US 2010/0018284 A1
(43) Pub. Date: Jan. 28, 2010

(54) STATIC RIG FOR VALVE TESTING

(75) Inventor: Otto Herman Varga, Bristol (GB)

Correspondence Address: BLISS MCGLYNN, P.C., 2075 WEST BIG BEAVER ROAD, SUITE 600, TROY, MI, 48084, US

(73) Assignee: SEETRU LIMITED, Bristol (GB)

(21) Appl. No.: 12/253,280

(22) Filed: Oct. 17, 2008

(30) Foreign Application Priority Data
Jul. 22, 2008 (GB) GB 0813366.2

(51) Int. Cl. G01L 27/00

(52) U.S. Cl. 73/1.72

(57) ABSTRACT

A static test rig, for a safety valve having an inlet and a disc movable to open and close the valve, comprises a test table having an aperture therethrough over which the valve can be mounted with its inlet open to the aperture, a gas chamber arranged under the table to admit compressed gas to the aperture thereby to apply a gas pressure to the valve disc, a push rod extending through the gas chamber and arranged to extend through the valve inlet and actuation means arranged to apply an axial push force to the push rod thereby to apply a push force to the disc simultaneously with the gas pressure.

### FIELD OF THE INVENTION

The present invention relates to the testing of valves, in particular safety valves. More specifically the present invention relates to test rigs on which spring loaded safety valves may be mounted, and which serves for the measurement of operating parameters of such valves.

### BACKGROUND TO THE INVENTION

Valves, in particular safety valves, which can be operational for long periods of time, can deteriorate with age. Various methods of testing valves are known, but often they do not provide accurate and reliable information on the state of the valve.

### SUMMARY OF THE INVENTION

The present invention provides a static test rig comprising a test table on which a safety valve can be mounted. The valve may be bolted, screwed or clamped to the test table. An air or gas cylinder may be arranged under the table to admit compressed gas to the valve inlet. A hydraulically or compressed gas operated push rod may pass through the cylinder to apply an axial push force to the disc, stem and valve spring assembly through the inlet simultaneously with any air or gas pressure.

The gas pressure acting and the push rod force applied may be independently regulated.

The static test rig may serves to determine the valve parameters set pressure, Condition Rating and effective seal area between disc and seat.

A force transducer may be arranged between the power ram and the push rod to sense and indicate the magnitude of the axial force applied.

A displacement sensor may monitor any push rod, valve disc and stem movement without access to any valve element from the top of the valve.

The displacement sensor may be of the laser type and may comprise an emitter and a target, and be arranged below the test table between an anchorage on the power ram housing or any point on the rig rigidly connected to it and a target on or rigidly connected to the ram push rod assembly.

An ultrasound or other high frequency vibration sensor may be attached to the valve or test rig to sense and signal the point of first leak from the valve on application of fluid pressure.

The push rod in the air cylinder may be exchangeable to suit the size of valve inlet.

The contact head of the push rod may be exchangeable to suit the configuration of the valve disc.

The contact head of the push rod may comprise a contact element freely radially self centering to accommodate any arc form of disc and to ensure accurate axial alignment for the pushing thrust.

Embodiments of the present invention can be used to measure various parameters of a safety valve, notably its set pressure, its Condition Rating™ and its effective seal area. Such measurements may be carried out on Safety Valves which have been dismounted from their service installation, and may or may not have been overhauled and reconditioned. In particular also, the measurements can be carried out on entirely new safety valves on which seals appended by the manufacturer have not been broken or interfered with in any way. In this way any parameters specified for the valve y be verified before the valve is put into service.

If the rig measurements are undertaken both before and after a reconditioning process, the effectiveness of such a process can be checked, and it can be seen if the valve may have been returned to the condition before installation, or indeed to the condition as new.

The fitting to the rig and also the measurements are desirably easy and rapid, so that large numbers of safety valves, such as in an oil refinery, can be rapidly dealt with.

The static rig, according to one embodiment of the invention comprises a robust structure supporting and offering a substantial test table to which the safety valve can be bolted, screwed or clamped, also hydraulically or pneumatically. In some embodiments the valve will be in a vertical position, and it will be held fluid tight against the appropriate face of the test table. Below the test table, co-axial with the valve, a cylinder may be disposed which can be pressurised with air, or another gas, to act upon the inlet of the safety valve. This air pressure can be regulated, by admitting or venting air, and constantly monitored, which is in some circumstances an essential feature of the test procedure.

A ram operated push rod passes axially through the air cylinder to contact the disc of the Safety Valve through the inlet, in order to exert an upward force upon it, in addition to any air pressure which may also be acting. The determination of the force so acting, and any attending disc movement, are the key elements of the test.

An embodiment of the invention incorporating a ram operated push rod will be described below by way of example only with the aid of the appended drawings.

### BRIEF DESCRIPTION OF THE DRAWINGS

FIG. 1 is a section through a test rig according to an embodiment of the invention; and

FIG. 2 is a section through the contact head of a test rig according to a second embodiment of the invention.

### DESCRIPTION OF THE PREFERRED EMBODIMENTS

First, however, various methods will be described by which the safety valve parameters can be calculated from the air pressure, ram force and disc displacement determinations, according to some embodiments of the invention, which are described by way of example only.

In some embodiments there may also be an ultrasonic sound or high frequency vibration detector strapped to the valve or rig, which will be capable of determining the pressure of very first leak. The pressure on the valve disc just sufficient to cause the valve to leak is designated ‘pressure set-to-leak’ (ps1). It should be noted here that at the pressure ps1 there will be, in general, no significant movement of the valve disc from the valve seat.

The first measurement on the rig is that of the total spring force Fc, exerted by the valve spring on the disc, and hence on the valve seat in the absence of any fluid pressure. This is achieved by a force measurement without any pressure in the air cylinder, also referred to as a cold test. The hydraulic ram is actuated for the push rod to make contact with the valve disc and to push against it until the spring force is completely balanced out, and the disc hovers in contact with the valve seat without exerting any force on it. This ram force is measured by a force transducer interposed between the ram and the push rod, and is denoted Fc, as already mentioned.

The next step is to introduce an air pressure pi into the cylinder, which is less than the pressure set-to-leak ps1, as ascertained by the absence of any leak signal from the ultrasound detector. In the presence of the air pressure pi a force is again applied to the disc until the “hovering condition” on the valve seat is reached, and this force value Fh is noted from the force transducer. At this point the first valve parameter result is obtained, i.e. that of the effective seal area A, given by

$$A \cdot pl = Fc - Fh . \\ Or \\ A = \frac{Fc - Fh}{pl} \qquad ( 1 )$$

Immediately the next parameter is obtained, as the set pressure, also designated pressure set-to-open pso. In fact direct physical consideration yields

pso=Fc/A (2)

The next important consideration is that in other than exceptional circumstances

ps1≦pso (3)

It follows that at the point of first leak the force exerted by the valve spring on the seat through the valve disc must include a sealing force f exceeding the force needed to counterbalance the fluid pressure acting over the effective seal area. Hence

$$f = Fc - A \cdot psl \\ and by ( 1 ) \\ f = Fc - \frac{psl}{pl} ( Fc - Fh ) \qquad ( 4 )$$

The final key valve parameter is the Condition Rating™ Q defined as

$$Q = 100 \frac{f}{Fc} \qquad ( 5 )$$

From (5), (4) and (1) and (2) it easily follows that

$$Q = 100 ( 1 - \frac{psl}{pso} ) \qquad ( 6 )$$

The value of ps1 can be determined either by increasing the ram force from Fh to Fh1 where the first ultrasound leak signal is detected, and writing

ps1=p1+Fh1/A (7),

or by raising the cylinder pressure direct from p1 to ps1, identified by the same ultrasound leak signal. The two methods should give identical results.

For the identification of the “hovering condition” of the disc on the valve seat for the measurement of the corresponding force several effective practices are available which provide substantially similar results. One method is to program the displacement sensor for a small but definitive separation of disc and valve seat. This might range from 10 μm to 0.5 mm, at which point the force transducer reading is picked up. The range of these possible separations can be understood from the fact that the rate of change of force in a small displacement is relatively small, once there is separation. This rate of change is governed by the spring rate, which is likely to be much lower than the rate of change of force imposed by the hydraulic ram in its thrust towards disc separation.

An alternative way of picking up the difference in the rate of change of pushing force is to inspect the force trace against time, or indeed the force trace against displacement, if the control program software allows this to be displayed. Such traces will allow a point of disc separation to be identified.

The other key sensor is the displacement sensor, to which repeated reference has already been made. This may be of a laser or alternative type, but it is fixed below the test table to co-operate with the ram-pushrod assembly, and does not require access to the top of the safety valve, where locked caps and seals are usually located. This allows for the testing of new or newly sealed valves, which is one purpose of the specified design.

The displacement sensor could be devised to pick up movement of the valve disc from the valve outlet by mechanical, optical or electronic means. In the case of atmospheric discharge valves such a device could pick up disc or plunger movement through a body aperture. However, the fixed sensor position below the test table allows for rapid operation, without the need to adapt the movement sensing to individual valves.

The ultrasound sensor, or high frequency vibration detector, to which reference has also been made, can in principle be located anywhere on the test valve or rig, but its preferred position is strapped or magnetically adhered to the outlet branch of the valve under test.

It is here that it is nearest to any origin of leakage noise. In the case of atmospheric discharge safety valves, the preferred position is the body of the valve itself.

It is also possible to listen for the first leak, as the human ear can be extremely sensitive. This simplifies the equipment, and may make it more mobile in certain cases.

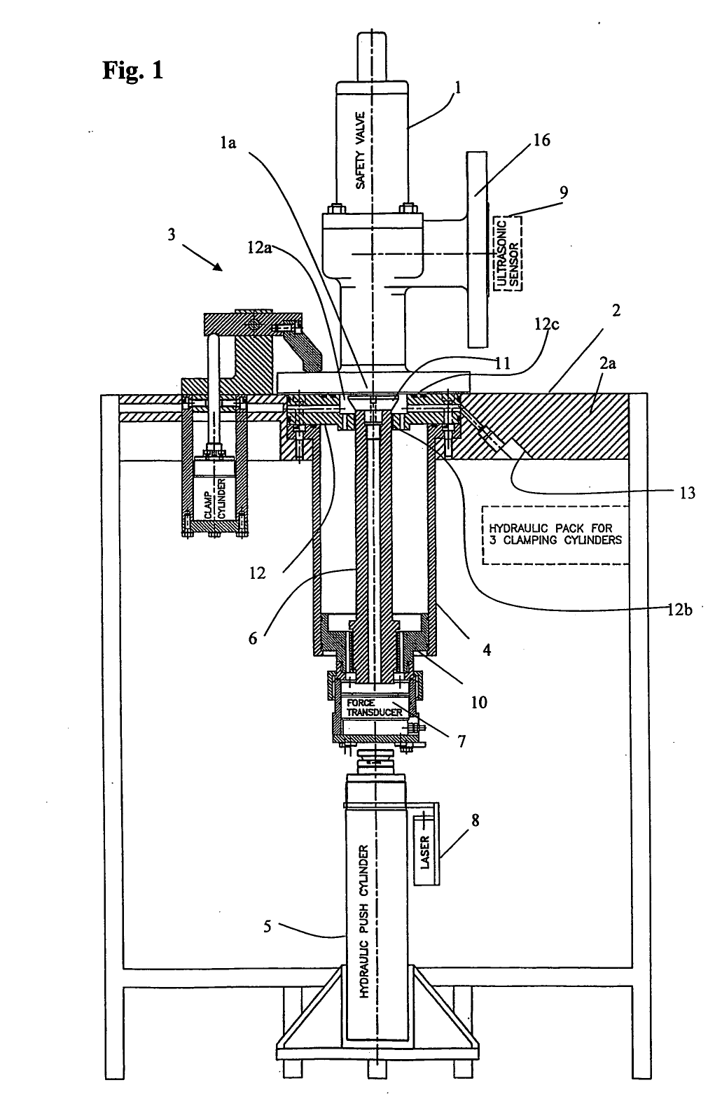

Referring now to the drawings and FIG. 1, 1 represents the safety valve mounted of the test table 2. The valve has a valve disc which engages with a valve seat to close the valve. The valve disc is supported on a valve stem and acted on by a spring which urges it into a closed position on the valve seat. In operation the valve is arranged to be opened by gas pressure at the valve inlet acting on the valve disc to push it off the valve seat against the force of the spring. The test table 2 comprises a main support 2a with a guide plate 12 let into it. The guide plate 12 has an aperture through it, the upper part of which forms an air inlet chamber 12a in its top surface, and the lower part of which is narrower and forms a guide aperture 12b. The valve 1 to be tested is place on the test table 2 with its inlet 1a over the air inlet chamber 12a, and is held in fluid tight position by the clamp mechanism 3. Seals 12c in the guide plate form a seal between the valve 1 and the guide plate 12, connecting the air inlet chamber 12a to the valve inlet 1a. The air cylinder 4 has its open upper end sealed against the underside of the guide plate 12 and extends centrally downwards from the test table 2, and has the push rod 6 passing through its middle. This in turn has a contact head 11 fitted to its top, which reaches to the valve disc through the safety valve inlet 1a. The push rod 6 is exchangeable for different sized valves, and is closely guided at the bottom in the air cylinder piston 10, which is slidable in the air cylinder 4, and at the top in the guide aperture 12b in the guide plate 12. The piston 10 is pressed upwards by the hydraulic ram 5 through the force transducer 7, which gives an electronic signal in accordance with the variable force exerted on the push rod 6, and hence upon the valve disc. Through the port 13 in the main support 2a of the table 2 air is admitted/vented to/from the air cylinder 4 via ports in the guide plate 12. A pressure sensor is arranged to monitor the air pressure in the cylinder 4 at the same time. Through the passages in the guide plate 12 and the air inlet chamber 12a, the air also acts upon the valve disc itself pushing it upwards to tend to open the valve. Thus, regulated air pressure, as well as regulated upwards axial force can be exerted upon the valve disc, and through it upon the stem and spring of the safety salve 1.

The movement of the force transducer housing, and hence the piston/push rod/valve disc is minutely monitored by the laser displacement sensor 8, which comprises a laser light source and detector unit 8a anchored to the housing of the hydraulic ram, and a target 8b mounted on the push rod assembly 6 so as to move vertically with the push rod. The laser sensor 8 therefore measures movement of the push rod, and hence movement imparted to the valve disc by the push rod. Finally, the ultrasonic sensor 9 is diagrammatically indicated as fixed to the outlet branch 1b of the valve 1, where it is arranged to sense vibration caused by leaking of air through the valve, which can occur before any measurable movement of the valve disc occurs. Thus all the mechanical and measurement dispositions are present to carry out the observations and calculations set out above.

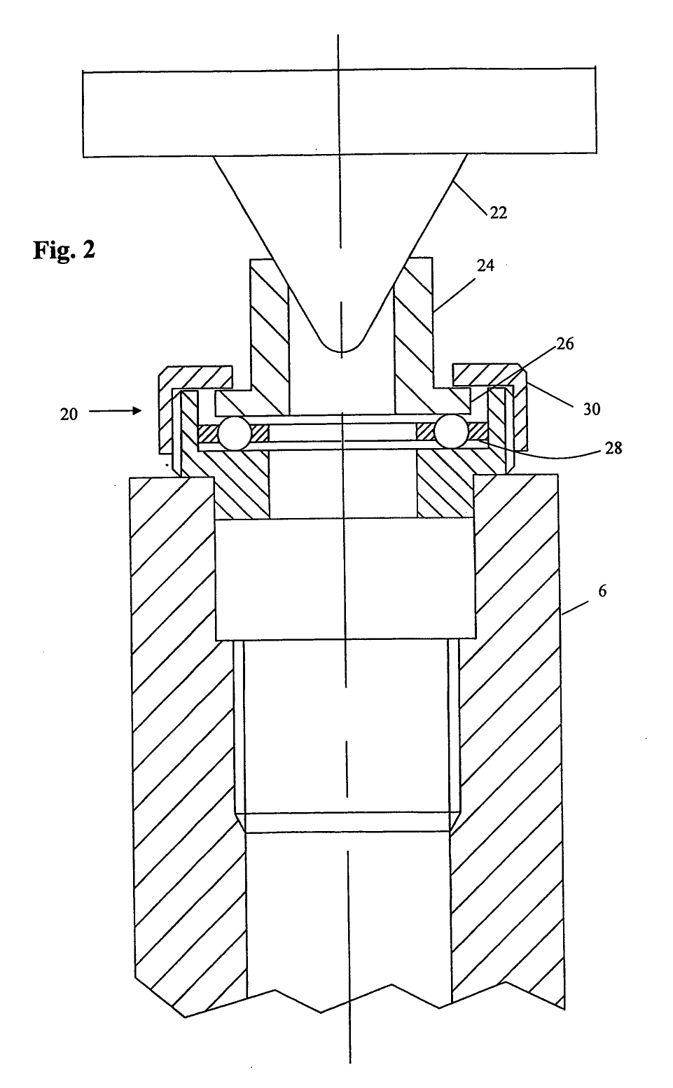

FIG. 2 illustrates an alternative contact head fitted 20 to the top of the push rod 6 for dome or pyramid shaped valve discs 22. This comprises an open tubular contact member 24 on its upper end. The tubular member 24 has a radial flange 26 at its lower end, which is supported on a bearing ring 28. A cap 30 captures the flange 26 to retain the contact member 24 against the bearing ring 28 but allows it to float in a horizontal plane, moving radially of the push rod 6. As the absolute concentricity of disc/valve stem assembly and push rod/ram cannot be guaranteed, the contact head according to FIG. 2 allows free radial self alignment between these components and assures the smooth push action emanating from the hydraulic ram 5.

In other embodiments of the invention other modifications can be made. For example, the push rod may extend through one aperture in the test table, and the air supply be introduced through a separate aperture, provided that the valve inlet covers both apertures when mounted on the table.

1. A static test rig for a safety valve having an inlet and a disc movable to open and close the valve, the test rig comprising a test table having at least one aperture therethrough over which the valve can be mounted, the at least one aperture including a gas supply aperture and the at least one aperture including a push rod aperture, a gas supply arranged to supply gas to the gas supply aperture to apply a gas pressure to the valve disc, a push rod extending through the push rod aperture, and an actuator arranged to apply an axial push force to the push rod thereby to apply a push force to the disc simultaneously with the gas pressure.

2. A test rig according to claim 1 wherein the at least one aperture includes one aperture which forms both the gas supply aperture and the pushrod aperture.

3. A test rig according to claim 1 wherein the at least one aperture comprises two apertures, one of which forms the gas supply aperture and the other of which forms the pushrod aperture.

4. A test rig according to claim 1 wherein the at least one aperture comprises an aperture over which the valve can be mounted with its inlet open to the aperture, the gas supply comprises a gas chamber arranged under the table to admit compressed gas to the aperture, and the push rod extends through the gas chamber and the aperture.

5. A test rig according to claim 1, further comprising gas pressure control means arranged to regulate the gas pressure.

6. A test rig according to claim 1 wherein the actuator is arranged to regulate the force on the push rod independently of the gas pressure.

7. A test rig according to claim 1 which serves to determine at least one of the following valve parameters: set pressure, condition rating and effective seal area between the disc and a seat of the valve.

8. A test rig according to claim 1, wherein the actuator is arranged to apply an axial force to the push rod and a force transducer is arranged between the actuator and the push rod to sense and indicate the magnitude of the axial force.

9. A test rig according to claim 1 further comprising a displacement sensor arranged to monitor movement of at least one of the push rod and the valve disc without access to any valve element from the top of the valve.

10. A test rig according to claim 8, wherein the displacement sensor comprises an emitter and a target, wherein one of the emitter and the target is arranged to move with the push rod.

11. A test rig according to claim 1 further comprising a vibration sensor arranged to sense and signal a point of first leak from the valve on application of fluid pressure.

12. A test rig according to claim 1 wherein the push rod is exchangeable to suit the size of valve inlet.

13. A test rig according to claim 1 wherein the push rod comprises an exchangeable contact head arranged to suit the configuration of the valve disc.

14. A test rig according to claim 1 wherein the push rod comprises a contact head which comprises a radially self centering contact element to ensure accurate axial alignment for the push force.
